(19) United States
(12) Patent Application Publication
(10) Pub. No.: US 2025/0294308 A1
(43) Pub. Date: Sep. 18, 2025

(54) CUSTOMIZED BINAURAL RENDERING OF AUDIO CONTENT

(71) Applicant: Dolby Laboratories Licensing Corporation, San Francisco, CA (US)

(72) Inventors: Ziran JIANG, Beijing (CN); Xuemei YU, Beijing (CN); Yanning CHE, Beijing (CN)

(73) Assignee: Dolby Laboratories Licensing Corporation, San Francisco, CA (US)

(21) Appl. No.: 18/860,375

(22) PCT Filed: May 3, 2023
(86) PCT No.: PCT/US2023/020874

§ 371 Date: Oct. 25, 2024

Related U.S. Application Data
(60) Provisional application No. 63/497,025, filed on Apr. 19, 2023.

(30) Foreign Application Priority Data
May 5, 2022 (WO) PCT/CN2022/090993

(51) Int. Cl. H04S 7/00; H04R 5/033; H04S 3/00

(52) U.S. Cl. CPC H04S 7/304; H04R 5/033; H04S 3/008; H04R 2420/07; H04S 2400/01; H04S 2400/11

(57) ABSTRACT

Methods, systems, and media for processing audio are provided. In some embodiments, a method for processing audio may involve receiving a stereo audio signal. The method may involve separating the stereo audio signal into steered signals and diffuse signals. The method may involve determining one or more diffuse signal modification parameters based on a current listening context, wherein the one or more diffuse signal modification parameters indicate a proportion of the diffuse signals to be re-distributed to one or more output channels in an output multichannel signal or a degree of attenuation to be applied to the diffuse signals. The method may involve generating the output multichannel signal based on the steered signals, the diffuse signals, and the one or more diffuse signal modification parameters. The method may involve providing the output multichannel signal to a virtualizer for rendering as a binaural audio signal for playing on a wearable device.

### CROSS-REFERENCE TO RELATED APPLICATIONS

This application claims priority to U.S. Provisional Application No. 63/497,025, filed

Apr. 19, 2023, and PCT Application No. PCT/CN2022/0901993, filed on May 5, 2022, each of which is incorporated by reference in its entirety.

### TECHNICAL FIELD

This disclosure pertains to systems, methods, and media for customized binaural rendering of audio content.

### BACKGROUND

Media content viewers are increasingly interested in spatial audio that can cause a perception of immersiveness. For example, when listening to immersive audio content, a listener may feel as if the audio content is surrounding them. However, rendering spatial audio content may be difficult, particularly in instances in which the sound is rendered binaurally via headphones or earbuds.

### NOTATION AND NOMENCLATURE

Throughout this disclosure, including in the claims, the terms “speaker,” “loudspeaker” and “audio reproduction transducer” are used synonymously to denote any sound-emitting transducer (or set of transducers). A typical set of headphones includes two speakers. A speaker may be implemented to include multiple transducers (e.g., a woofer and a tweeter), which may be driven by a single, common speaker feed or multiple speaker feeds. In some examples, the speaker feed(s) may undergo different processing in different circuitry branches coupled to the different transducers.

Throughout this disclosure, including in the claims, the expression performing an operation “on” a signal or data (e.g., filtering, scaling, transforming, or applying gain to, the signal or data) is used in a broad sense to denote performing the operation directly on the signal or data, or on a processed version of the signal or data (e.g., on a version of the signal that has undergone preliminary filtering or pre-processing prior to performance of the operation thereon).

Throughout this disclosure including in the claims, the expression “system” is used in a broad sense to denote a device, system, or subsystem. For example, a subsystem that implements a decoder may be referred to as a decoder system, and a system including such a subsystem (e.g., a system that generates X output signals in response to multiple inputs, in which the subsystem generates M of the inputs and the other X−M inputs are received from an external source) may also be referred to as a decoder system.

Throughout this disclosure including in the claims, the term “processor” is used in a broad sense to denote a system or device programmable or otherwise configurable (e.g., with software or firmware) to perform operations on data (e.g., audio, or video or other image data). Examples of processors include a field-programmable gate array (or other configurable integrated circuit or chip set), a digital signal processor programmed and/or otherwise configured to perform pipelined processing on audio or other sound data, a programmable general purpose processor or computer, and a programmable microprocessor chip or chip set.

### SUMMARY

Methods, systems, and media for customized binaural rendering of audio content are provided. In some embodiments, a method involves receiving a stereo audio signal. The method may further involve separating the stereo audio signal into steered signals and diffuse signals, wherein the steered signals correspond to directional content in the stereo audio signal, and wherein the diffuse signals correspond to background content in the stereo audio signal. The method may further involve determining one or more diffuse signal modification parameters based on a current listening context, wherein the one or more diffuse signal modification parameters indicate a proportion of the diffuse signals to be re-distributed to one or more output channels in an output multichannel signal or a degree of attenuation to be applied to the diffuse signals. The method may further involve generating the output multichannel signal based on the steered signals, the diffuse signals, and the one or more diffuse signal modification parameters. The method may further involve providing the output multichannel signal to a virtualizer for rendering as a binaural audio signal for playing on a wearable device.

In some examples, the one or more output channels comprise at least one of a left channel, a right channel, or a center channel.

In some examples, generating the output multichannel signal comprises: obtaining a spreading matrix; generating a modified spreading matrix using the spreading matrix and the one or more diffuse signal modification parameters; generating diffuse multichannel signals using the modified spreading matrix; and generating the output multichannel signal based on the diffuse multichannel signals and the steered signals. In some examples, the one or more diffuse signal modification parameters cause the proportion of the diffuse signals to be re-distributed into the one or more output channels, and wherein generating the modified spreading matrix comprises determining a matrix dot product of: a norm associated with the spreading matrix and the matrix representing the diffuse signal modification parameters, a matrix associated with the one or more diffuse signal modification parameters, and the spreading matrix. In some examples, the one or more diffuse signal modification parameters comprise one diffuse signal redistribution modification parameter indicative of a re-distribution of the diffuse signals in the multichannel outputs, and wherein the norm normalizes energy of the diffuse signals. In some examples, the one or more diffuse signal modification parameters cause the degree of attenuation to be applied to the diffuse signals, and wherein generating the output multichannel signal comprises performing energy normalization configured to cause an energy of the output multichannel signal to be the same as an energy of the stereo audio signal. In some examples, normalizing the energy is performed by one of: an upmixer that generates the output multichannel signals, or the virtualizer.

In some examples, the current listening context comprises one of: a movie content viewing mode, a music listening mode, or a game playing mode. In some examples, the current listening context is the movie content viewing mode, and wherein the one or more diffuse signal modification parameters are within a range of about 0.8-1. In some examples, the current listening context is the music listening mode, and wherein the one or more diffuse signal modification parameters are within a range of about 0-0.2. In some examples, the current listening context is the game playing mode, and wherein the one or more diffuse signal modification parameters have values less than those associated with the movie content viewing mode.

In some examples, the one or more diffuse signal modification parameters are received from a user of the wearable device. In some examples, the one or more diffuse signal modification parameters are received via a user interface.

In some examples, generating the output multichannel signal occurs on a companion user device associated with the wearable device, and wherein the virtualizer comprises one or more components that execute on the wearable device. In some examples, the method further involves transmitting data to the wearable device from the companion user device via a BLUETOOTH communication protocol.

In some examples, the wearable device comprises one of earbuds or headphones.

In some examples, the wearable device comprises one or more sensors that collect sensor data usable for generating headtracking information associated with a wearer of the wearable device.

In some examples, the virtualizer is configured to render the binaural audio signal based on the output multichannel signal and the headtracking information.

Some or all of the operations, functions and/or methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. Accordingly, some innovative aspects of the subject matter described in this disclosure can be implemented via one or more non-transitory media having software stored thereon.

At least some aspects of the present disclosure may be implemented via an apparatus. For example, one or more devices may be capable of performing, at least in part, the methods disclosed herein. In some implementations, an apparatus is, or includes, an audio processing system having an interface system and a control system. The control system may include one or more general purpose single-or multi-chip processors, digital signal processors (DSPs), application specific integrated circuits (ASICs), field programmable gate arrays (FPGAs) or other programmable logic devices, discrete gates or transistor logic, discrete hardware components, or combinations thereof.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram of an example system that includes an upmixer that generates a customized multichannel output signal in accordance with some implementations.

FIGS. 2A, 2B, and 2C depict diagrams illustrating the effect of various values of a diffuse signal modification parameter in accordance with some implementations.

FIG. 3 is a diagram of an example upmixer in accordance with some implementations.

FIG. 4 is a flowchart of an example process for generating a multichannel output signal in accordance with some implementations.

FIG. 5 is a flowchart of an example process for generating diffuse multichannel signals using diffuse attenuation signal parameters in accordance with some implementations.

FIG. 6 is a flowchart of an example process for generating diffuse multichannel signals that distribute diffuse signals in accordance with some implementations.

FIG. 7 shows a block diagram that illustrates examples of components of an apparatus capable of implementing various aspects of this disclosure.

Like reference numbers and designations in the various drawings indicate like elements.

### DETAILED DESCRIPTION OF EMBODIMENTS

Media content viewers are increasingly interested in spatial audio that causes a perception of immersiveness. For example, when listening to immersive audio content, a listener may feel as if the audio content is surrounding them. However, rendering spatial audio content may be difficult, particularly in instances in which the sound is rendered binaurally via headphones or earbuds. For example, spatial audio, when rendered binaurally via headphones or earbuds, may cause a perception of audio scene instability when the user moves their head. By way of example, if a listener is listening to music, and accordingly desires a perception of the vocalist and/or instrumentalists as being in front of the listener, the listener may perceive jumps or discontinuities as the spatial audio is rendered binaurally and as the listener moves their head (e.g., to look around at their surroundings). Rendering spatial audio via headphones and/or earbuds that perform head orientation determination may be especially challenging, because listeners may have different preferences for whether to prioritize immersiveness or scene stability, which may additionally depend on the type of audio content being listened to. For example, a listener may prioritize scene stability, in which direct or steered signals (such as vocals or instrumental music) is perceived as pinned in front of the listener when listening to music. In other words, such a rendering may cause the listener to perceive they are listening to the music in front of a front speaker. Conversely, a listener may prioritize immersiveness when listening to audio content associated with a movie. Customizing the listening experience of spatial audio when presented via headphones or earbuds may be especially challenging. As used herein, “immersiveness” refers to rendering audio data in a manner that is perceived as three-dimensional and surrounding the user. Immersive audio content may involve rendering audio objects as having a given spatial position with a particular azimuth and/or elevation with respect to the listener. For example, audio data rendered in an immersive manner may yield a listening experience where audio sounds are rendered in a manner that is perceived as surrounding the listener, rather than only in front of the listener. As a specific example, audio content rendered in an immersive manner may include a sound of an airplane or helicopter rendered such that the listener perceives the sound as being overhead. The techniques disclosed herein allow a user to adjust the audio scene, for example, by allowing audio objects to be pinned at a particular perceived location (e.g., at a screen rendering the content), or by allowing the audio objects to be perceived as enveloping or surrounding the user. For example, the techniques described herein allow a listener to balance scene stability, which generally refers to a listening experience in which the audio object does not change position as the listener moves their head (e.g., from side to side, as they look around), with immersiveness. Allowing the listener to balance scene stability with immersiveness may allow a listener to customize the listening experience based on the type of content the listener is listening to.

Disclosed herein are techniques for generating a customized multichannel output signal based on a current listening context. The customized multichannel output signal may be generated by considering diffuse signal modification parameters which cause diffuse signals to either be attenuated (thereby causing direct or steered signals to be perceived as more prominent, which may in turn increase a perception of scene stability) or by re-distributing at least a portion of diffuse signals to one or more output channels, such as the left, right, or center channels. In instances in which at least a portion of the diffuse signals are re-distributed, the degree to which diffuse signals are distributed may be dependent on the listening context. For example, in an instance in which the listening context indicates that the listener is watching a movie, none of the diffuse signals, or a relatively small proportion of the diffuse signals, may be distributed to the left, right, and center channels, thereby maintaining the feeling of immersiveness. Conversely, in an instance in which the listening context indicates that the listener is listening to music or playing a game, a larger proportion of the diffuse signals may be distributed to one or more output channels, thereby increasing the perception of scene stability when the user moves their head.

In some implementations, the customized multichannel output signal may be generated by an upmixer component of a device. The device may be a user device (e.g., a mobile phone, a tablet computer, a laptop computer, a desktop computer, a game console, a television, etc.) that causes audio content to be presented, e.g., via paired or connected headphones or ear buds. The customized multichannel output signal may then be rendered as a binaural audio signal by a virtualizer component. In some embodiments, the virtualizer component may be part of the headphones or earbuds such that the rendering as a binaural audio signal may be dependent on the user's head orientation.

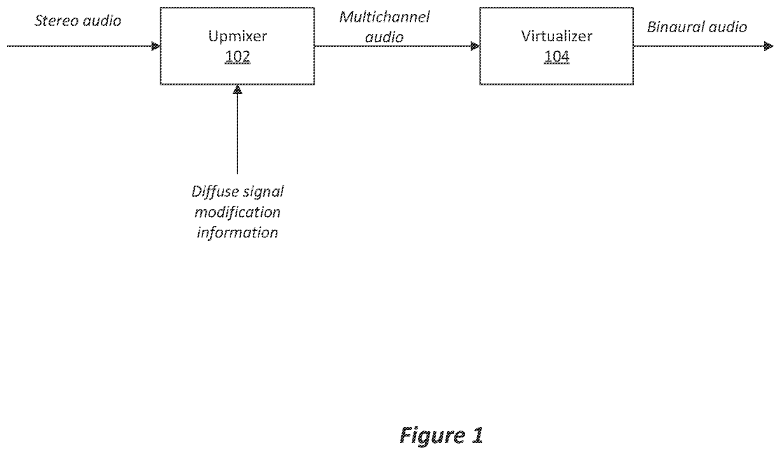

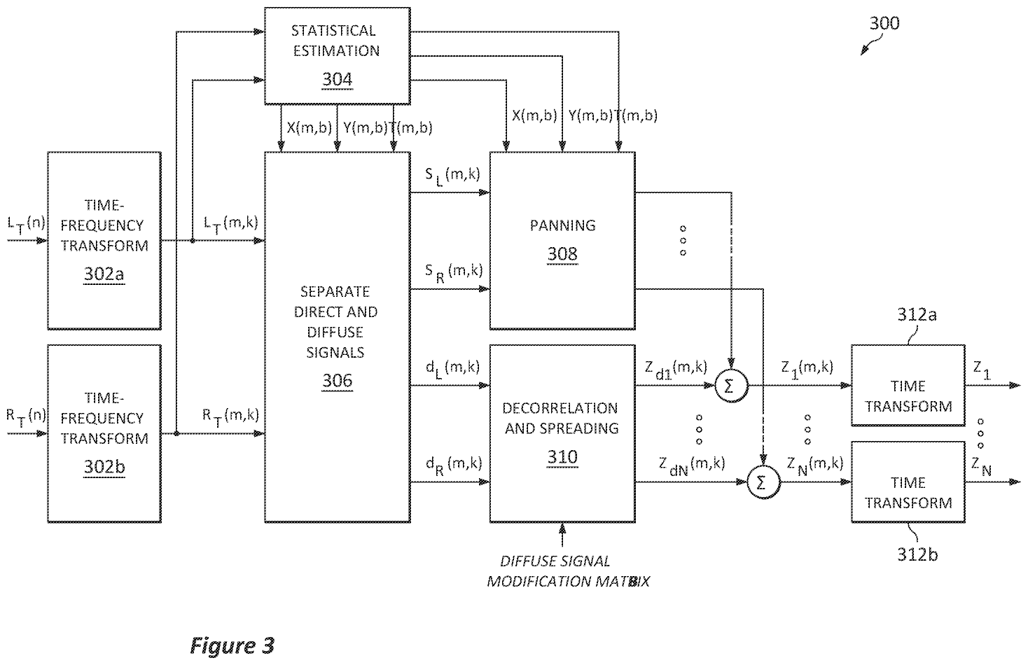

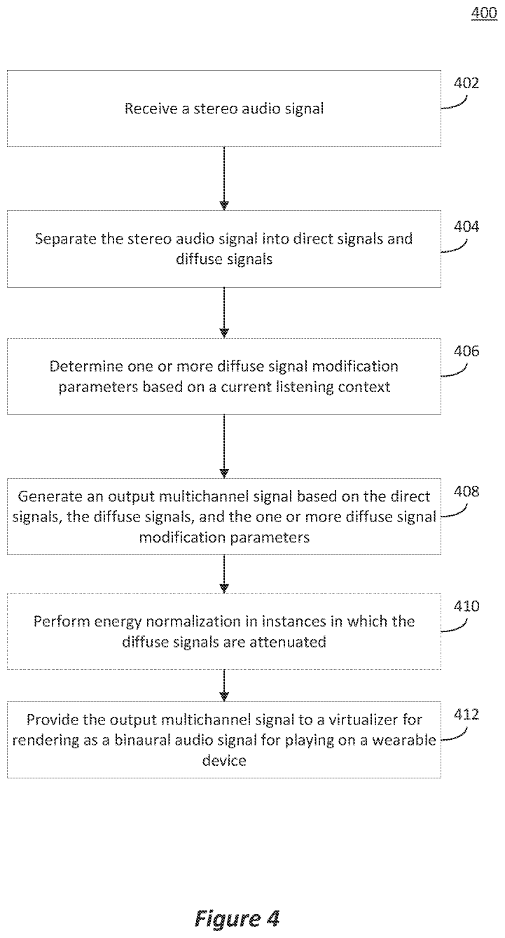

FIG. 1 is a block diagram of a system that is configured to generate and utilize a customized binaural audio rendering in accordance with some implementations. As illustrated, an upmixer 102 receives a stereo audio signal that includes a left audio signal and a right audio signal. Upmixer 102 additionally receives diffuse signal modification information. The diffuse signal modification information may indicate a manner in which diffuse signals are to be attenuated or re-allocated to one or more channels, such as one or more of the left, right, and center channels of a customized multi-channel output signal generated by upmixer 102. The diffuse signal modification information may correspond to a current listening context. Example listening contexts include the user listening to music, watching a movie, playing a game (e.g., a computer game), etc. The diffuse signal modification information may include one or more parameters, each set of one or more parameters associated with a given listening context. The sets of one or more parameters may be stored (e.g., in memory) of a device being used to present audio content such that the device retrieves a set of diffuse signal modification parameters that corresponds to a current listening context. Upmixer 102 may then generate a multichannel audio signal. An example upmixer system is shown in and described below in connection with FIG. 3, and techniques for generating a customized multichannel audio signal based on the diffuse signal attenuation information are shown in and described below in connection with FIGS. 4, 5, and 6.

Upmixer 102 may provide the multichannel audio signal to virtualizer 104. Note that, in some implementations, upmixer 102 may execute on a companion device (e.g., a mobile phone, a tablet computer, a laptop computer, etc.) that provides audio signals for playback by a paired set of headphones or earbuds, and virtualizer 104 may execute on the paired headphones or earbuds. In such implementations, upmixer 102 may transmit the multichannel audio signal to virtualizer 104 via BLUETOOTH, or another wireless communication protocol. Note that, in some implementations, upmixer 102 and virtualizer 104 may be implemented on the same device.

Virtualizer 104 may receive the multichannel audio signal and may render the multichannel audio signal as a binaural audio signal suitable for playback via, e.g., headphones or earbuds. Note that virtualizer 104 may render the multichannel audio signal based on head tracking information obtained using one or more sensors (e.g., one or more accelerometers, one or more gyroscopes, one or more magnetometers), etc. The one or more sensors may be disposed in or on the headphones or the ear buds. It should be noted that, because the multichannel audio signal is generated based on the present listening context (e.g., indicative of a type of audio content or video content being consumed by the user), the diffuse signals may be attenuated (e.g., to make audio signals that are to be rendered in the front of the user to be boosted relative to the diffuse signals) or re-allocated to one or more channels, such as one or more of the left, right, and center channels of the upmixed multichannel audio signal in a manner that is dependent on the listening context. Subsequently, the virtualizer may render the multichannel audio signal as a binaural audio signal in a manner that is dependent on the head orientation of the listener. Consequently, the binaural audio signal may be presented in a manner that is dependent on both the listener's head orientation and the listening context such that diffuse signals are attenuated or re-distributed in a customized manner that aligns with a user's listening preferences for various types of audio content. By way of example, in an instance in which the listening context corresponds to watching a movie, the binaural audio signals may be rendered in a manner that is substantially immersive regardless of user head orientation. As another example, in an instance in which the listening context corresponds to listening to music, the binaural audio signal may be rendered in a manner such that vocals and instrumentals are perceived as being in front of the user regardless of user head orientation, thereby improving scene stability.

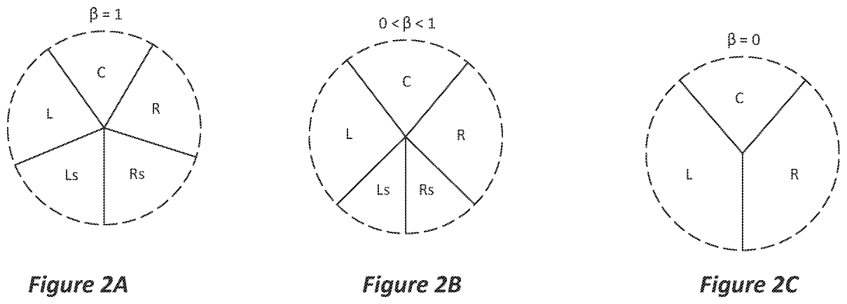

FIGS. 2A, 2B, and 2C illustrate the effects of varying values of a diffuse signal modification parameter, generally represented herein as β. In general, β indicates a degree to which diffuse signals are spread or re-allocated to other channels (e.g., left, right, and/or center channels) of a multi-channel mix. Note that, in FIGS. 2A, 2B, and 2C, Lₛ and Rₛ represent the left and right surround signals, respectively, and L, R, and C represent the left, right, and center channels of a 5.1 upmixed signals, respectively. Referring to FIG. 2A, in an instance in which β is 1, none of the diffuse signals from the left and right surround channels are spread or re-allocated to the left, right, and center channels. Referring to FIG. 2B, in an instance in which β is between 0 and 1, some portion of the diffuse signals from the left and right surround channels are spread or re-allocated to the left, right, and center channels, but some portion of the diffuse signal remains in the left and right surround channels. Referring to FIG. 2C, in an instance in which β is 0, all of the diffuse signals from the left and right surround channels are spread or re-allocated to the left, right, and center channels. Note that distribution of the diffuse signal may be implemented for other upmix formats, such as a 7.1 upmix, or the like.

In some implementations, diffuse signal modification may be performed by an upmixer. In some implementations, the upmixer may be a component or module of a user device that provides audio content for playback. For example, the user device may be a mobile phone, a tablet computer, a laptop computer, a desktop computer, a gaming console, a television, etc. The upmixed may be configured to receive stereo audio signals (e.g., a left signal and a right signal) and generate a customized multichannel output signal based on diffuse signal modification parameters. The diffuse signal modification parameters may be received (e.g., obtained and/or identified) by the upmixer based on a current listening context of a user of the user device. The upmixer may be configured to separate direct signals and diffuse signals, where direct signals correspond to e.g., vocal sounds and/or instrumental sounds, and the diffuse signals correspond to generally ambient and/or environmental sounds. The upmixer may be configured to pan the direct signals such that the direct signals are rendered as if positioned at a single point. The upmixer may be configured to decorrelate and spread the diffuse signals such that the diffuse signals are either attenuated or re-allocated around the output channels, thereby affecting the scene stability and/or the immersiveness of the audio content as experienced by the listeners. The upmixer may be configured to combine the panned steered signals and the spread and/or attenuated diffuse signals into a customized multichannel output signal. Note that the upmixer may be configured to receive stereo signals in the time domain and generate multichannel output signals in the time domain. However, in some implementations, the upmixer may be configured to perform processing generally in the frequency domain. In other words, in some embodiments, the upmixer may convert received stereo signals to the frequency domain prior to separating steered and diffuse signals, spreading and/or attenuating diffuse signals to other channels, generating a combined multichannel output signal, etc. The upmixer may then transform the multichannel output signal from the frequency domain to the time domain prior to providing the multichannel output signals to the virtualizer for rendering.

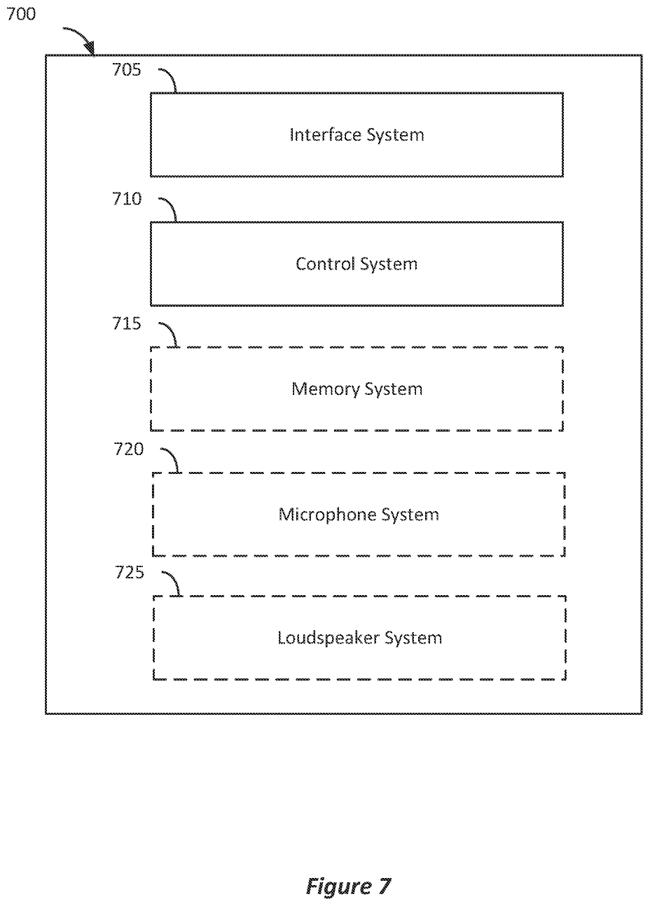

FIG. 3 is a block diagram of an example upmixer 300 in accordance with some implementations. In some implementations, upmixer 300 may be implemented using one or more processors or controllers, e.g., of a user device (e.g., a mobile phone, a tablet computer, a laptop computer, a desktop computer, a gaming console, etc.). An example of such a controller is control system 710 of FIG. 7.

As illustrated, upmixer 300 may receive stereo audio signals, generally represented herein as L_{T}(n) (e.g., the left stereo signal) and R_{T}(n) (e.g., the right stereo signal), where n represents the current audio frame. The stereo signals may be transformed from the time domain to the frequency domain using time-frequency transform blocks 302a and 302b. For example, time-frequency transform block 302a may output a frequency domain representation of the left stereo signal, generally represented herein as L_{T}(m, k), and time-frequency transform block 302b may output a frequency domain representation of the right stereo signal, generally represented herein as R_{T}(m, k), where m represents the time block index, and k represents the frequency index.

The frequency domain representation of the stereo audio signals may be provided to statistical estimation block 304. Statistical estimation block 304 may generate estimated parameters X(m, b), Y(m, b), and T(m, b), which may be provided to separation block 306. The frequency domain representation of the stereo audio signals may also be provided to separation block 306, as shown in FIG. 3.

Separation block 306 may be configured to separate the direct signals and the diffuse signals. The direct signals may be represented as S_{L}(m, k) and S_{R}(m, k) for left and right direct signals, respectively. The diffuse signals may be represented as d_{L}(m, k) and d_{R}(m, k). In some implementations, the diffuse signals may be obtained by subtracting the estimated steered signals from the input stereo signals, where the subtraction is performed in the frequency domain. For example, in some implementations, the left and right diffuse signals may be determined by:

$$[ \begin{matrix}{d}_{L} ( m , k ) \\ {d}_{R} ( m , k )\end{matrix} ] = [ \begin{matrix}{L}_{T} ( m , k ) \\ {R}_{T} ( m , k )\end{matrix} ] - W ( m , b ) [ \begin{matrix}{L}_{T} ( m , k ) \\ {R}_{T} ( m , k )\end{matrix} ]$$

In the equation given above, W(m, b) represents a steered signal separation matrix.

The direct signals S_{L}(m, k) and S_{R}(m, k) may be provided to panning block 308. Panning block 308 may be configured to locate the direct signals at a particular position. Note that panning block 308 may utilize the parameters generated by statistical estimation block 304. Additionally, note that panning block 308 is configured to output a multichannel output of direct signals. For example, the multichannel direct signals may have N channels, where N is the total number of channels. By way of example, for a 5.1 upmix, N is 5, whereas for a 7.1 upmix, Nis 7.

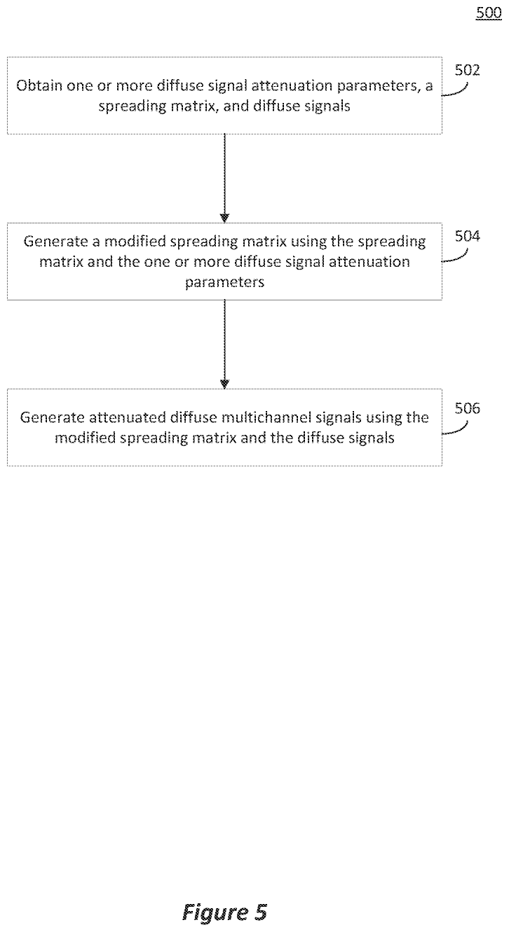

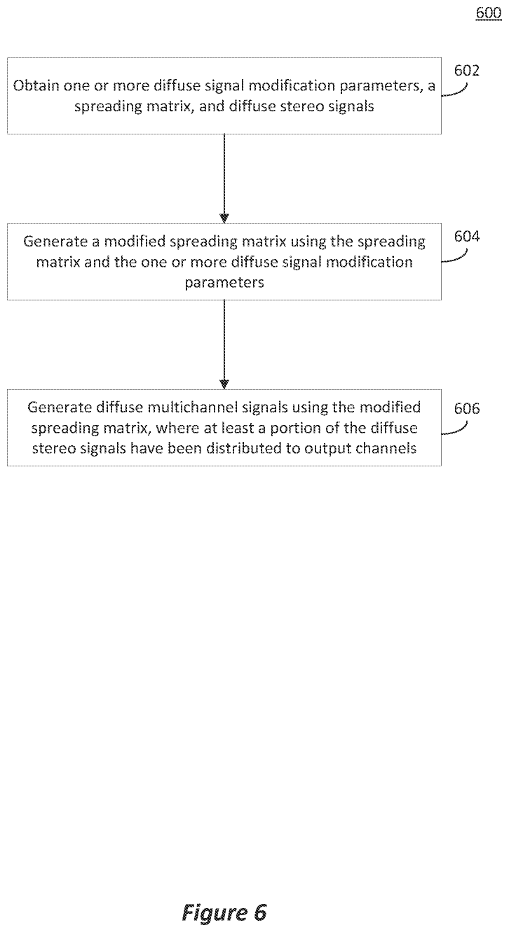

Decorrelation and spreading block 310 may receive the diffuse signals d_{L}(m, k) and d_{R}(m, k). Decorrelation and spreading block 310 may additionally be configured to receive, obtain, or determine diffuse signal modification parameters, which may be specified in a diffuse energy adjustment matrix B. The diffuse signal modification parameters may be received or determined based on a current listening context. Decorrelation and spreading block 310 may be configured to modify the diffuse signals such that the diffuse signals are attenuated (thereby making the direct signals more prominent) or such that the diffuse signals are re-allocated to the other output channels (e.g., the left, right, and center channels in a 5.1 upmix). Decorrelation and spreading block 310 may modify the diffuse signals by generating a modified spreading matrix that controls a degree to which diffuse signals are present in various output channels. The spreading matrix, generally represented herein as O, may be obtained based on parameters generated by statistical estimation block 304, and may be modified based on the diffuse signal modification parameters. Techniques for generating a modified spreading matrix are shown in and described below in connection with FIGS. 5 and 6. The modified diffuse signals are generally represented herein as Z_{d1}(m, k), . . . Z_{dN}(m, k), where N is the number of channels in the multichannel output signals.

The panned multichannel direct signals may be combined with the modified diffuse signals to generate the output multichannel signals in the frequency domain, generally represented herein as Z_{d1}(m, k), . . . Z_{dN}(m, k), where N is the number of channels in the multichannel output signals. The output signals may then be transformed to the time domain to generate the multichannel output signals in the time domain, represented herein as Z₁(n), . . . Z_{N}(n), where n is the audio frame number and N is the number of output channels. The transform to the time domain may be implemented via a set of frequency-time transform blocks, such as block 312a and 312b.

As described above, an upmixer may generate a customized multichannel output based on a current listening context. The current listening context may be indicative of a type of content being presented by a user device (e.g., whether the content is music content, video content such as a movie or television show, game content, etc.), whether the audio content is being presented via paired headphones or earbuds, etc. For example, diffuse signal modification parameters may be applied in instances in which the audio content is being presented via paired headphones or earbuds and may not be applied in instances in which the audio content is presented by the user device directly (e.g., via speakers of the user device). In some implementations, the diffuse signal modification parameters may be obtained, retrieved, or otherwise determined based on the type of content being presented. For example, the user device may store different sets of diffuse signal modification parameters applicable to different types of content. By way of example, the diffuse signal modification parameters may include diffuse signal attenuation parameters that cause the diffuse signals to be attenuated (and thereby cause vocals and instrumental sounds to be rendered as more prominent) responsive to determining that the current listening context corresponds to music content being played. As another example, the diffuse signal modification parameters may include a first set of diffuse signal modification parameters that cause the diffuse signals to not be re-allocated to other output channels at all responsive to determining that the current listening context corresponds to playback of a movie, thereby causing the movie audio content to be rendered in a more immersive manner. As yet another example, the diffuse signal modification parameters may include a second set of diffuse signal modification parameters that cause a portion of the diffuse signals to be re-allocated or re-distributed to other output channels responsive to determining that the current listening context corresponds to playing a video game, thereby causing increased scene stability as the user moves their head at the expense of a less immersive perception.

Regardless of whether diffuse signals are attenuated or re-allocated to other output channels, the diffuse signal modification parameters may be applied by modifying a spreading matrix to generate a modified spreading matrix. The modified spreading matrix may therefore indicate a degree to which the diffuse signals are attenuated or re-distributed. Modified diffuse signals may then be determined based on the modified spreading matrix. A customized multichannel output signal may then be determined by combining multichannel modified diffuse signals with multichannel direct signals and transforming the combined signal to the time domain. Note that, in instances in which the diffuse signals are attenuated (e.g., in an instance in which the diffuse signal modification parameters correspond to parameters that cause direct signals, such as vocals and/or instrumentals, to be rendered more prominently), the multichannel output signal may have less energy than the input stereo signals. Accordingly, in such cases, in some embodiments, the multichannel output signal may be normalized such that the output signal has the same energy as the input stereo signals.

FIG. 4 is a flowchart of an example process 400 for generating a customized multichannel output signal in accordance with some embodiments. In some implementations, blocks of process 400 may be executed on a user device. For example, the user device may be one that causes audio content (or audio content associated with video content) to be played back via paired headphones or earbuds. Examples of such user devices include mobile phones, tablet computers, laptop computers, desktop computers, game consoles, televisions, etc. Blocks of process 400 may be executed by one or more processors or controllers of the user device. An example of such a controller is control system 710, shown in and described below in connection with FIG. 7. In some implementations, blocks of process 400 may be executed in an order other than what is shown in FIG. 4. In some implementations, two or more blocks of process 400 may be executed substantially in parallel. In some implementations, one or more blocks of process 400 may be omitted.

Process 400 may begin at 402 by receiving a stereo audio signal. The stereo audio signal may be received by an upmixer. As described above, the stereo audio signals may generally be represented herein as L_{T}(n) (e.g., the left stereo signal) and R_{T}(n) (e.g., the right stereo signal), where n represents the current audio frame. Note that, after receiving the stereo audio signals, process 400 may transform the stereo audio signals from the time domain to the frequency domain. For example, process 400 may utilize a short-time Fourier transform (STFT).

At 404, process 400 may separate the stereo audio signals into direct signals and diffuse signals. Process 400 may separate the stereo signals into the direct signals and the diffuse signals based on a statistical estimation performed using the frequency domain representation of the stereo audio signals, as shown in and described above in connection with FIG. 3. The direct signals are generally referred to herein as S_{L}(m, k) and S_{R}(m, k) for the left and right direct signals, respectively, and the diffuse signals are generally referred to herein as d_{L}(m, k) and d_{R}(m, k), for the left and right diffuse signals, respectively. In some implementations, the diffuse signals may be obtained by subtracting the estimated steered signals from the input stereo signals, e.g., using a steered signal separation matrix, as described above in connection with FIG. 3.

At 406, process 400 can determine one or more diffuse signal modification parameters based on a current listening context. As described above, the current listening context may be indicative of a type of audio content being presented (e.g., whether the audio content is music content, audio content associated with a movie or television show, audio content associated with a video game, etc.) and/or whether the audio content is being played back via headphones and/or earbuds.

In some implementations, the diffuse signal modification parameter(s) may include parameters configured to attenuate the diffuse signals. Attenuation may be performed in cases in which increasing scene stability during user head movement is to be prioritized. For example, attenuation of the diffuse signals may be performed in instances in which the current listening context indicates that the audio content is music that is being listened to using paired headphones or earbuds.

In some implementations, the diffuse signal modification parameter(s) may include parameters that indicate a degree to which the diffuse signals are to be re-distributed to one or moreoutput channels (e.g., one or more of the left, right, and/or center channels), thereby causing change in a degree of immersiveness perceived by the user. For example, in instances in which the diffuse signal modification parameter(s) indicate that the diffuse signals are not to be re-distributed to one or more output channels (e.g., in instances in which the current listening context indicates that the audio content is associated with a movie or television show, and thus, a high perception of immersiveness is desired), the diffuse signal modification parameter(s) may not re-distribute any portion of the diffuse signals. Conversely, in instances in which the diffuse signal modification parameter(s) indicate that the diffuse signals are to be at least partially re-distributed to other output channels (e.g., in instances in which the current listening context indicates the audio content is associated with content other than a movie or television show, such as music, a video game, a podcast, etc.), at least a portion of the diffuse signals may be re-distributed to, e.g., the left, right, and center channels, thereby increasing a perception of scene stability at the expense of the perception of immersiveness.

Note that the diffuse signal modification parameter(s) may be specified by a user of the user device or may be programmed into the user device by, e.g., a manufacturer of the user device. The diffuse signal modification parameter(s) may include different sets of diffuse signal modification parameter(s), each applicable to a different listening context. Process 400 may then retrieve the diffuse signal modification parameter(s) applicable to the current listening context. In instances in which the diffuse signal modification parameter(s) are specified and/or modified by a user of the user device, the parameters may be specified or modified via a user interface, e.g., presented on the user device. For example, the user interface may include a slider control or other user interface control that allows a user to adjust the diffuse signal modification parameters for different listening contexts. The settings may then be stored, e.g., in memory of the user device, for use during future listening sessions. Note that in some embodiments, diffuse signal modification parameters may be received from a wearable device (e.g., a pair of earbuds or headphones) and/or from a companion user device (e.g., a paired mobile device).

At 408, process 400 may generate an output multichannel signal based on the direct signals, the diffuse signals, and the one or more diffuse signal modification parameters. For example, process 400 may apply the diffuse signal modification parameters by applying the diffuse signal modification parameters to a spreading matrix to generate a modified spreading matrix. The modified spreading matrix may then be used to generate modified diffuse signals, which may be attenuated or re-distributed relative to the original diffuse signals. The modified diffuse signals may then be combined with the direct signals to generate the output multichannel signal. In some implementations, the output multichannel signal may then be transformed to the time domain. An example of a process for generating attenuated diffuse signals by generating a modified spreading matrix is shown in and described below in connection with FIG. 5. An example of a process for distributing diffuse signals to other output channels by generating a modified spreading matrix is shown in and described below in connection with FIG. 6.

In some embodiments, at 410, process 400 may optionally perform energy normalization. For example, energy normalization may be performed in instances in which the diffuse signals were attenuated at block 408 to account for the reduction in total energy in the output multichannel signal when utilizing attenuated diffuse signals. The energy normalization may cause the normalized multichannel signal to have a similar total energy as that of the stereo audio signals received at block 402. Note that, in instances in which the diffuse signals are not attenuated but are rather re-distributed to other output channels, energy normalization need not be performed, and block 410 may be omitted. Additionally, it should be noted that, energy normalization may be performed either by the upmixer or by a virtualizer. In instances in which energy normalization is performed by a virtualizer, block 410 may be performed after block 412, described below. Energy normalization may be performed in either the time domain or in the frequency domain.

At 412, process 400 may provide the output multichannel signal to a virtualizer for rendering as a binaural audio signal for playing on a wearable device. The wearable device may include headphones or earbuds. The virtualizer may be implemented either on the user device that provides the audio content or on the wearable device (e.g., the headphones or the earbuds). In some implementations, the wearable device may include one or more sensors usable to determine a head orientation of the user. The virtualizer may then render the binaural audio signal based on the head orientation. Accordingly, in instances in which the diffuse signal modification parameters were parameters that prioritized scene stability, the binaural audio signal may be rendered such that direct signals (e.g., vocals, instrumentals, etc.) are rendered as perceived in front of the user regardless of the user's head orientation. Conversely, in instances in which the diffuse signal modification parameters were parameters that prioritized immersiveness, the binaural audio signal my be rendered such that the diffuse signals are distributed in a manner that causes a perception of immersiveness even as the user moves their head. Note that because the diffuse signal modification parameters are specific to the listening context, which may be indicative of the type of audio content being presented, scene stability may be prioritized for some types of audio content whereas immersiveness is prioritized for other types of audio content. Moreover, because, in some implementations, the diffuse signal modification parameters may be set or adjusted by an end user of the user device, the listener may have control over whether scene stability or immersiveness is prioritized for different types of audio content, and the degree to which each is prioritized.

In some implementations, the diffuse signal modification parameters may include diffuse signal attenuation parameters that cause diffuse signals to be attenuated. This may cause the steered or direct signals to be rendered in a manner that is perceived as pinned in front of the listener, even when the listener moves their head while wearing headphones or earbuds. In other words, the steered, or direct signals, may be rendered more prominently, and rendered in a manner that is perceived as fixed to the front, thereby increasing a sense of scene stability for the listener even while the listener moves their head. Attenuation of diffuse signals may be performed in instances in which the current listening context is listening to music content, because the steered or direct signals may include vocals or instrumental music that is advantageously rendered more prominently. In some implementations, attenuation of the diffuse signals may involve applying diffuse signal attenuation parameters to a spreading matrix to generate a modified spreading matrix. The modified spreading matrix may be used to generate modified diffuse signals which are attenuated relative to the original diffuse signals. Note that, because the diffuse signals are attenuated, a multichannel output signal that includes the attenuated diffuse signals and the multichannel direct signals may be lower in energy relative to the original stereo signal. Accordingly, normalization may be performed to normalize the energy of the multichannel output signals to that of the original stereo signal such that the rendered binaural signal, when presented, is not lower in volume than desired.

FIG. 5 is a flowchart of an example process 500 for attenuating diffuse signals in accordance with some implementations. In some implementations, blocks of process 500 may be executed on a user device. For example, the user device may be one that causes audio content (or audio content associated with video content) to be played back via paired headphones or earbuds. Examples of such user devices include mobile phones, tablet computers, laptop computers, desktop computers, game consoles, televisions, etc. Blocks of process 500 may be executed by one or more processors or controllers of the user device. An example of such a controller is control system 710, shown in and described below in connection with FIG. 7. In some implementations, blocks of process 500 may be executed in an order other than what is shown in FIG. 5. In some implementations, two or more blocks of process 500 may be executed substantially in parallel. In some implementations, one or more blocks of process 500 may be omitted.

Process 500 can begin at 502 by obtaining one or more diffuse signal attenuation parameters, a spreading matrix, and diffuse signals. Note that the diffuse signals may be provided in the frequency domain. As described above in connection with FIG. 3, the diffuse signals may be represented as d₁(m, k), . . . dⱼ(m, k), where j is the number of diffuse signals, m is the time block index, and k is the frequency band. The spreading matrix may be represented herein as O, which may have dimensions N×j, where N is the number of channels. For example, for a 5.1 channel upmix, N may be 5, and j may be 2. In other examples, N may be 7, 9, etc., and j may be 2, 3, 4, etc. In some embodiments, the spreading matrix may be generated based on statistical estimation parameters, e.g., as estimated by statistical estimation block 304, as shown in and described above in connection with FIG. 3. The diffuse signal attenuation parameters may generally be represented herein as matrix B, which may have dimensions N×j, similar to matrix O. The diffuse signal attenuation parameters may be obtained from memory of the user device and may have been set based on user preferences relating to a degree by which the diffuse signals are to be attenuated for various listening contexts (e.g., for various types of audio content). Note that, in some implementations, each element of matrix 8 may be between 0 and 1, where a value of 0 indicates that the diffuse signals are to be entirely attenuated, and a value of 1 indicates that the diffuse signals are not to be attenuated to any degree.

At 504, process 500 may generate a modified spreading matrix using the spreading matrix and the one or more diffuse signal attenuation parameters. For example, in some implementations, the modified spreading matrix, O′, may be determined by:

$${O}^{′} = B \cdot O = [ \begin{matrix}{β}_{1 , 1} & … & {β}_{1 , j} \\ ⋮ & ⋱ & ⋮ \\ {β}_{N , 1} & … & {β}_{N , j}\end{matrix} ] \cdot [ \begin{matrix}{O}_{1 , 1} & … & {O}_{1 , j} \\ ⋮ & ⋱ & ⋮ \\ {O}_{N , 1} & … & {O}_{N , j}\end{matrix} ]$$

At 506, process 500 can generate attenuated diffuse multichannel signals using the modified spreading matrix and the diffuse multichannel signals. Note that the diffuse multichannel signals, generally represented herein as Z_{d1}, . . . Z_{dN}, are conventionally generated by multiplying the spreading matrix by a vector formed by the diffuse signals. However, to generate the attenuated diffuse multichannel signals, process 500 may multiply the modified spreading matrix, which incorporates the diffuse signal attenuation parameters, by the vector formed by the diffuse signals. For example, in some embodiments, the diffuse multichannel signals may be determined by:

$$[ \begin{matrix}{Z}_{d 1}^{′} ( m , k ) \\ ⋮ \\ {Z}_{dN}^{′} ( m , k )\end{matrix} ] = {O}^{′} x \vec{d} = [ \begin{matrix}{O}_{1 , 1} & … & {O}_{1 , j} \\ ⋮ & ⋱ & ⋮ \\ {O}_{N , 1} & … & {O}_{N , j}\end{matrix} ] \times [ \begin{matrix}{d}_{1} ( m , k ) \\ ⋮ \\ {d}_{j} ( m , k )\end{matrix} ]$$

The diffuse multichannel signals may then be combined with the multichannel direct signals, as shown in and described above in connection with FIGS. 3 and 4 to generate a multichannel output signal in the frequency domain. The frequency domain signal may then be transformed to the time domain, as described above in connection with FIGS. 3 and 4.

Note that, because the total energy in the output multichannel signal is attenuated due to the attenuation of the diffuse signals, the energy may be normalized prior to rendering the binaural audio signal. For example, the energy may be normalized based on the stereo signal. Such normalization may be performed by an upmixer, a virtualizer, or any other component.

In some implementations, the diffuse signal modification parameters may include parameters that cause at least a portion of the diffuse signals to be re-distributed to one or more output channels, such a left, right, and/or center channel. Such re-distribution may serve to effectively balance scene stability of presentation of immersive audio content and immersiveness. For example, when spatial audio is rendered from a device such as a tablet computer or a mobile phone and presented via a user's headphone or earbuds, distributing at least a portion of diffuse signals to other output channels may increase scene stability perception, particularly as the user's head orientation changes. In some cases, the degree to which diffuse signals are re-distributed may depend on the listening context. For example, for a listening context in which the user is watching a movie, none of the diffuse signals, or a relatively low proportion of the diffuse signals (e.g., 10%, 15%, etc.) may be re-distributed in order to prioritize a feeling of immersiveness. As another example, for a listening context in which the user is viewing or playing a game, a relatively larger proportion of the diffuse signals may be re-distributed (e.g., larger relative to the proportion distributed for a movie-watching context). By way of example, when viewing or playing a game, 60%, 70%, 80%, etc. of the diffuse signals may be re-distributed.

Similar to what is described above in connection with FIG. 5, in some embodiments, modified diffuse signals may be determined by generating a modified spreading matrix using the diffuse signal modification parameters. However, unlike what is described above in connection with FIG. 5, because the total energy of the multichannel output signals should not be attenuated, the modified spreading matrix may be generated using a normalization parameter that serves to maintain a norm (e.g., the Frobenius norm) of the spreading matrix. Additionally, in some implementations, the diffuse signal modification parameters may include a single diffuse signal modification parameter. Use of a single diffuse signal modification parameter may allow greater ease of user configuration.

FIG. 6 is a flowchart of an example process 600 for distributing diffuse signals in accordance with some implementations. In some implementations, blocks of process 600 may be executed on a user device. For example, the user device may be one that causes audio content (or audio content associated with video content) to be played back via paired headphones or earbuds. Examples of such user devices include mobile phones, tablet computers, laptop computers, desktop computers, game consoles, televisions, etc. Blocks of process 600 may be executed by one or more processors or controllers of the user device. An example of such a controller is control system 710, shown in and described below in connection with FIG. 7. In some implementations, blocks of process 600 may be executed in an order other than what is shown in FIG. 6. In some implementations, two or more blocks of process 600 may be executed substantially in parallel. In some implementations, one or more blocks of process 600 may be omitted.

Process 600 can begin at 602 by obtaining one or more diffuse signal modification parameters, a spreading matrix, and diffuse stereo signals. Note that the diffuse stereo signals may be provided in the frequency domain. As described above in connection with FIG. 3, the diffuse stereo signals may be represented as d₁(m, k), . . . dⱼ(m, k), where j is the number of diffuse signals, m is the time block index, and k is the frequency band. The spreading matrix may be represented herein as O, which may have dimensions N×j, where N is the number of channels. For example, for a 5.1 channel upmix, N may be 5, and j may be 2. In other examples, N may be 7, 9, etc., and j may be 2, 3, 4, etc. In some embodiments, the spreading matrix may be generated based on statistical estimation parameters, e.g., as estimated by statistical estimation block 304, as shown in and described above in connection with FIG. 3.

In some implementations, the diffuse signal modification parameters may generally be represented herein as matrix B, which may have dimensions N×j, similar to matrix O. Alternatively, in some implementations, the diffuse signal modification parameter may be a single parameter, generally represented herein as 8. Use of a single parameter may reduce complexity in allowing a user to configure the diffuse signal modification parameter(s) for various listening contexts. The diffuse signal modification parameter(s) may be obtained from memory of the user device and may have been set based on user preferences relating to a degree by which the diffuse signals are to be distributed to other output channels for various listening contexts (e.g., for various types of audio content). Note that, in some implementations, each element of matrix B may be between 0 and 1, where a value of 0 indicates that the diffuse signals in specified channels (e.g., the left surround, and the right surround) are fully redistributed to other output channels (e.g., the left, right, and/or center channels), and a value of 1 indicates that the diffuse signals are not to be redistributed.

At 604, process 600 can generate a modified spreading matrix using the spreading matrix and the one or more diffuse signal modification parameters. Because the multichannel output signal should not be attenuated when diffuse signals are re-distributed to other output channels, the modified spreading matrix may be determined using one or more normalization parameters. For example, the modified spreading matrix may be determined by a dot product of a normalization matrix, a matrix representing the diffuse signal modification parameters, and the spreading matrix. By way of example, in an instance in which the diffuse signal modification parameters comprise multiple diffuse signal modification parameters, each corresponding to a particular output channel and diffuse signal, and that is arranged in the matrix B, the modified spreading matrix may be determined by:

$${O}^{′} = NORM \cdot B \cdot O = [ \text{} \begin{matrix}{norm}_{1 , 1} & … & {norm}_{i , j} \\ ⋮ & ⋱ & ⋮ \\ {norm}_{N , 1} & … & {norm}_{N , j}\end{matrix} ] \cdot [ \begin{matrix}{β}_{1 , 1} & … & {β}_{1 , j} \\ ⋮ & ⋱ & ⋮ \\ {β}_{N , 1} & … & {β}_{N , j}\end{matrix} ] \cdot [ \begin{matrix}{O}_{1 , 1} & … & {O}_{1 , j} \\ ⋮ & ⋱ & ⋮ \\ {O}_{N , 1} & … & {O}_{N , j}\end{matrix} ]$$

In the equation given above, elements of the NORM matrix may be determined as values that cause a Frobenius norm of O′ to be the same as the Frobenius norm of O.

As another example, in an instance in which the diffuse signal modification parameters comprise a single diffuse signal modification parameter β, the modified spreading matrix may be determined by:

$${O}^{′} = [ \begin{matrix}norm & norm \\ norm & norm \\ norm & norm \\ 1 & 1 \\ 1 & 1\end{matrix} ] \cdot [ \begin{matrix}1 & 1 \\ 1 & 1 \\ 1 & 1 \\ β & β \\ β & β\end{matrix} ] \cdot [ \begin{matrix}{O}_{1 , 1} & {O}_{1 , 2} \\ {O}_{2 , 1} & {O}_{2 , 2} \\ {O}_{3 , 1} & {O}_{3 , 2} \\ {O}_{4 , 1} & {O}_{4 , 2} \\ {O}_{5 , 1} & {O}_{5 , 2}\end{matrix} ]$$

In the example equation given above, the normalization matrix, the diffuse signal modification matrix, the spreading matrix may each have dimensions N by j, where N represents the number of output channels in the upmix, and j represents the number of diffuse signals. In some implementations, the normalization matrix may be used to keep the Frobenius norm of the spreading matrix, O, unchanged. In the equation given above, and for the example case of five output channels (N) and two diffuse signals (j), the value of norm used in the normalization matrix may be determined by:

$$norm = \sqrt{\frac{2 - {β}^{2} * {\sum }_{i = 4}^{5} {\sum }_{j = 1}^{2} {O}_{ij}^{2}}{{\sum }_{i = 1}^{3} {\sum }_{j = 1}^{2} {O}_{ij}^{2}}}$$

At 606, process 600 can generate diffuse multichannel signals using the modified spreading matrix, where at least a portion of the diffuse stereo signals have been distributed to output channels. The modified diffuse multichannel signals are generally represented herein as Z_{d1}, . . . Z_{dN}, and are conventionally generated by multiplying the spreading matrix by a vector formed by the diffuse signals. However, to generate the modified diffuse multichannel signals, process 500 may multiply the modified spreading matrix, which incorporates the diffuse signal modification parameters, by the vector formed by the diffuse signals. For example, in some embodiments, the diffuse multichannel signals may be determined by:

$$[ \begin{matrix}{Z}_{d 1}^{′} ( m , k ) \\ ⋮ \\ {Z}_{dN}^{′} ( m , k )\end{matrix} ] = {O}^{′} x \vec{d} = [ \begin{matrix}{O}_{1 , 1} & … & {O}_{1 , j} \\ ⋮ & ⋱ & ⋮ \\ {O}_{N , 1} & … & {O}_{N , j}\end{matrix} ] \times [ \begin{matrix}{d}_{1} ( m , k ) \\ ⋮ \\ {d}_{j} ( m , k )\end{matrix} ]$$

By way of example, in an instance in which there are five output channels (N) and two diffuse signals (j), the diffuse multichannel signals may be determined by:

$$[ \begin{matrix}{Z}_{d 1}^{′} ( m , k ) \\ {Z}_{d 2}^{′} ( m , k ) \\ {Z}_{d 3}^{′} ( m , k ) \\ {Z}_{d 4}^{′} ( m , k ) \\ {Z}_{d 5}^{′} ( m , k )\end{matrix} ] = [ \begin{matrix}{O}_{1 , 1}^{′} & {O}_{1 , 2}^{′} \\ {O}_{2 , 1}^{′} & {O}_{2 , 2}^{′} \\ {O}_{3 , 1}^{′} & {O}_{3 , 2}^{′} \\ {O}_{4 , 1}^{′} & {O}_{4 , 2}^{′} \\ {O}_{5 , 1}^{′} & {O}_{5 , 2}^{′}\end{matrix} ] \times [ \begin{matrix}{d}_{l} ( m , k ) \\ {d}_{r} ( m , k )\end{matrix} ]$$

The diffuse multichannel signals may then be combined with the multichannel direct signals, as shown in and described above in connection with FIGS. 3 and 4 to generate a multichannel output signal in the frequency domain. The frequency domain signal may then be transformed to the time domain, as described above in connection with FIGS. 3 and 4.

FIG. 7 is a block diagram that shows examples of components of an apparatus capable of implementing various aspects of this disclosure. As with other figures provided herein, the types and numbers of elements shown in FIG. 7 are merely provided by way of example. Other implementations may include more, fewer and/or different types and numbers of elements. According to some examples, the apparatus 700 may be configured for performing at least some of the methods disclosed herein. In some implementations, the apparatus 700 may be, or may include, a television, one or more components of an audio system, a mobile device (such as a cellular telephone), a laptop computer, a tablet device, a smart speaker, or another type of device.

According to some alternative implementations the apparatus 700 may be, or may include, a server. In some such examples, the apparatus 700 may be, or may include, an encoder. Accordingly, in some instances the apparatus 700 may be a device that is configured for use within an audio environment, such as a home audio environment, whereas in other instances the apparatus 700 may be a device that is configured for use in “the cloud,” e.g., a server.

In this example, the apparatus 700 includes an interface system 705 and a control system 710. The interface system 705 may, in some implementations, be configured for communication with one or more other devices of an audio environment. The audio environment may, in some examples, be a home audio environment. In other examples, the audio environment may be another type of environment, such as an office environment, an automobile environment, a train environment, a street or sidewalk environment, a park environment, etc. The interface system 705 may, in some implementations, be configured for exchanging control information and associated data with audio devices of the audio environment. The control information and associated data may, in some examples, pertain to one or more software applications that the apparatus 700 is executing.

The interface system 705 may, in some implementations, be configured for receiving, or for providing, a content stream. The content stream may include audio data. The audio data may include, but may not be limited to, audio signals. In some instances, the audio data may include spatial data, such as channel data and/or spatial metadata. In some examples, the content stream may include video data and audio data corresponding to the video data.

The interface system 705 may include one or more network interfaces and/or one or more external device interfaces (such as one or more universal serial bus (USB) interfaces). According to some implementations, the interface system 705 may include one or more wireless interfaces. The interface system 705 may include one or more devices for implementing a user interface, such as one or more microphones, one or more speakers, a display system, a touch sensor system and/or a gesture sensor system. In some examples, the interface system 705 may include one or more interfaces between the control system 710 and a memory system, such as the optional memory system 715 shown in FIG. 7. However, the control system 710 may include a memory system in some instances. The interface system 705 may, in some implementations, be configured for receiving input from one or more microphones in an environment.

The control system 710 may, for example, include a general purpose single-or multi-chip processor, a digital signal processor (DSP), an application specific integrated circuit (ASIC), a field programmable gate array (FPGA) or other programmable logic device, discrete gate or transistor logic, and/or discrete hardware components.

In some implementations, the control system 710 may reside in more than one device. For example, in some implementations a portion of the control system 710 may reside in a device within one of the environments depicted herein and another portion of the control system 710 may reside in a device that is outside the environment, such as a server, a mobile device (e.g., a smartphone or a tablet computer), etc. In other examples, a portion of the control system 710 may reside in a device within one environment and another portion of the control system 710 may reside in one or more other devices of the environment. For example, a portion of the control system 710 may reside in a device that is implementing a cloud-based service, such as a server, and another portion of the control system 710 may reside in another device that is implementing the cloud-based service, such as another server, a memory device, etc. The interface system 705 also may, in some examples, reside in more than one device.

In some implementations, the control system 710 may be configured for performing, at least in part, the methods disclosed herein. According to some examples, the control system 710 may be configured for implementing methods of attenuating diffuse signals, distributing diffuse signals to other output channels, or the like.

Some or all of the methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. The one or more non-transitory media may, for example, reside in the optional memory system 715 shown in FIG. 7 and/or in the control system 710. Accordingly, various innovative aspects of the subject matter described in this disclosure can be implemented in one or more non-transitory media having software stored thereon. The software may, for example, determine or obtain diffuse signal attenuation parameters, generate an output multichannel signal based on the diffuse signal attenuation parameters, etc. The software may, for example, be executable by one or more components of a control system such as the control system 710 of FIG. 7.

In some examples, the apparatus 700 may include the optional microphone system 720 shown in FIG. 7. The optional microphone system 720 may include one or more microphones. In some implementations, one or more of the microphones may be part of, or associated with, another device, such as a speaker of the speaker system, a smart audio device, etc. In some examples, the apparatus 700 may not include a microphone system 720. However, in some such implementations the apparatus 700 may nonetheless be configured to receive microphone data for one or more microphones in an audio environment via the interface system 710. In some such implementations, a cloud-based implementation of the apparatus 700 may be configured to receive microphone data, or a noise metric corresponding at least in part to the microphone data, from one or more microphones in an audio environment via the interface system 710.

According to some implementations, the apparatus 700 may include the optional loudspeaker system 725 shown in FIG. 7. The optional loudspeaker system 725 may include one or more loudspeakers, which also may be referred to herein as “speakers” or, more generally, as “audio reproduction transducers.” In some examples (e.g., cloud-based implementations), the apparatus 700 may not include a loudspeaker system 725. In some implementations, the apparatus 700 may include headphones. Headphones may be connected or coupled to the apparatus 700 via a headphone jack or via a wireless connection (e.g., BLUETOOTH).

Some aspects of present disclosure include a system or device configured (e.g., programmed) to perform one or more examples of the disclosed methods, and a tangible computer readable medium (e.g., a disc) which stores code for implementing one or more examples of the disclosed methods or steps thereof. For example, some disclosed systems can be or include a programmable general purpose processor, digital signal processor, or microprocessor, programmed with software or firmware and/or otherwise configured to perform any of a variety of operations on data, including an embodiment of disclosed methods or steps thereof. Such a general purpose processor may be or include a computer system including an input device, a memory, and a processing subsystem that is programmed (and/or otherwise configured) to perform one or more examples of the disclosed methods (or steps thereof) in response to data asserted thereto.

Some embodiments may be implemented as a configurable (e.g., programmable) digital signal processor (DSP) that is configured (e.g., programmed and otherwise configured) to perform required processing on audio signal(s), including performance of one or more examples of the disclosed methods. Alternatively, embodiments of the disclosed systems (or elements thereof) may be implemented as a general purpose processor (e.g., a personal computer (PC) or other computer system or microprocessor, which may include an input device and a memory) which is programmed with software or firmware and/or otherwise configured to perform any of a variety of operations including one or more examples of the disclosed methods. Alternatively, elements of some embodiments of the inventive system are implemented as a general purpose processor or DSP configured (e.g., programmed) to perform one or more examples of the disclosed methods, and the system also includes other elements (e.g., one or more loudspeakers and/or one or more microphones). A general purpose processor configured to perform one or more examples of the disclosed methods may be coupled to an input device (e.g., a mouse and/or a keyboard), a memory, and a display device.

Another aspect of present disclosure is a computer readable medium (for example, a disc or other tangible storage medium) which stores code for performing (e.g., coder executable to perform) one or more examples of the disclosed methods or steps thereof.

While specific embodiments of the present disclosure and applications of the disclosure have been described herein, it will be apparent to those of ordinary skill in the art that many variations on the embodiments and applications described herein are possible without departing from the scope of the disclosure described and claimed herein. It should be understood that while certain forms of the disclosure have been shown and described, the disclosure is not to be limited to the specific embodiments described and shown or the specific methods described.

1. A method of processing audio, the method comprising:
receiving a stereo audio signal;
separating the stereo audio signal into steered signals and diffuse signals, wherein the steered signals correspond to directional content in the stereo audio signal, and wherein the diffuse signals correspond to background content in the stereo audio signal;
determining one or more diffuse signal modification parameters based on a current listening context, wherein the one or more diffuse signal modification parameters indicate a proportion of the diffuse signals to be re-distributed to one or more output channels in an output multichannel signal or a degree of attenuation to be applied to the diffuse signals;
generating the output multichannel signal based on the steered signals, the diffuse signals, and the one or more diffuse signal modification parameters; and
providing the output multichannel signal to a virtualizer for rendering as a binaural audio signal for playing on a wearable device.

2. The method of claim 1, wherein the one or more output channels comprise at least one of a left channel, a right channel, or a center channel.

3. The method of claim 1, wherein generating the output multichannel signal comprises:
obtaining a spreading matrix;
generating a modified spreading matrix using the spreading matrix and the one or more diffuse signal modification parameters;
generating diffuse multichannel signals using the modified spreading matrix; and
generating the output multichannel signal based on the diffuse multichannel signals and the steered signals.

4. The method of claim 3, wherein the one or more diffuse signal modification parameters cause the proportion of the diffuse signals to be re-distributed into the one or more output channels, and wherein generating the modified spreading matrix comprises determining a matrix dot product of: a norm associated with the spreading matrix and the matrix representing the diffuse signal modification parameters, a matrix associated with the one or more diffuse signal modification parameters, and the spreading matrix.

5. The method of claim 4, wherein the one or more diffuse signal modification parameters comprise one diffuse signal redistribution modification parameter indicative of a re-distribution of the diffuse signals in the multichannel outputs, and wherein the norm normalizes energy of the diffuse signals.

6. The method of claim 3, wherein the one or more diffuse signal modification parameters cause the degree of attenuation to be applied to the diffuse signals, and wherein generating the output multichannel signal comprises performing energy normalization configured to cause an energy of the output multichannel signal to be the same as an energy of the stereo audio signal.

7. The method of claim 6, wherein normalizing the energy is performed by one of: an upmixer that generates the output multichannel signals, or the virtualizer.

8. The method of any one of claim 1, wherein the current listening context comprises one of: a movie content viewing mode, a music listening mode, or a game playing mode.

9. The method of claim 8, wherein the current listening context is the movie content viewing mode, and wherein the one or more diffuse signal modification parameters are within a range of 0.8-1.

10. The method of claim 8, wherein the current listening context is the music listening mode, and wherein the one or more diffuse signal modification parameters are within a range of 0-0.2.

11. The method of claim 8, wherein the current listening context is the game playing mode, and wherein the one or more diffuse signal modification parameters have values less than those associated with the movie content viewing mode.

12. The method of any one of claim 1, wherein the one or more diffuse signal modification parameters are received from a user of the wearable device.

13. The method of claim 12, wherein the one or more diffuse signal modification parameters are received via a user interface.

14. The method of any one of claim 1, wherein generating the output multichannel signal occurs on a companion user device associated with the wearable device, and wherein the virtualizer comprises one or more components that execute on the wearable device.

15. The method of claim 14, further comprising transmitting data to the wearable device from the companion user device via a BLUETOOTH communication protocol.

16. The method of claim 1, wherein the wearable device comprises one of earbuds or headphones.

17. The method of claim 1, wherein the wearable device comprises one or more sensors that collect sensor data usable for generating headtracking information associated with a wearer of the wearable device.

18. The method of claim 17, wherein the virtualizer is configured to render the binaural audio signal based on the output multichannel signal and the headtracking information.

19. An electronic device comprising:
one or more processors; and
a non-transitory computer-readable medium storing instructions that, upon execution by the one or more processors, cause the electronic device to:
receive a stereo audio signal;
separate the stereo audio signal into steered signals and diffuse signals, wherein the steered signals correspond to directional content in the stereo audio signal, and wherein the diffuse signals correspond to background content in the stereo audio signal;
determine one or more diffuse signal modification parameters based on a current listening context, wherein the one or more diffuse signal modification parameters indicate a proportion of the diffuse signals to be re-distributed to one or more output channels in an output multichannel signal or a degree of attenuation to be applied to the diffuse signals;
generate the output multichannel signal based on the steered signals, the diffuse signals, and the one or more diffuse signal modification parameters; and
provide the output multichannel signal to a virtualizer for rendering as a binaural audio signal for playing on a wearable device.

20. A non-transitory computer-readable medium storing instructions that, upon execution by one or more processors of an electronic device, cause the electronic device to:
receive a stereo audio signal:
separate the stereo audio signal into steered signals and diffuse signals, wherein the steered signals correspond to directional content in the stereo audio signal, and wherein the diffuse signals correspond to background content in the stereo audio signal;
determine one or more diffuse signal modification parameters based on a current listening context, wherein the one or more diffuse signal modification parameters indicate a proportion of the diffuse signals to be re-distributed to one or more output channels in an output multichannel signal or a degree of attenuation to be applied to the diffuse signals;
generate the output multichannel signal based on the steered signals, the diffuse signals, and the one or more diffuse signal modification parameters; and
provide the output multichannel signal to a virtualizer for rendering as a binaural audio signal for playing on a wearable device.
